(19) United States
(12) Patent Application Publication
(10) Pub. No.: US 2016/0134650 A1
(43) Pub. Date: May 12, 2016

(54) SYSTEM, METHOD, AND APPARTUS FOR PROACTIVE CYBERSECURITY

(71) Applicants: Justin Farmer, Longwood, FL (US); Travis Fischer, Aurora, CO (US)

(72) Inventors: Justin Farmer, Longwood, FL (US); Travis Fischer, Aurora, CO (US)

(73) Assignee: KERNEL, INC., Aurora, CO (US)

(21) Appl. No.: 14/937,603

(22) Filed: Nov. 10, 2015

Related U.S. Application Data
(60) Provisional application No. 62/077,415, filed on Nov. 10, 2014.

(51) Int. Cl. H04L 29/06

(52) U.S. Cl. CPC H04L 63/1416; H04L 63/1425; H04L 63/1433

(57) ABSTRACT

The present disclosure describes a device, software package, method and system for active scanning, testing, and risk assessment of networks. The present disclosure describes a device that may be installed on a network, control of network traffic between the network and outside networks may be controlled, or may pass through device. Embodiments may scan and test both the internal and external network assets for security vulnerabilities. The results may be communicated via a cloud-based service to remote servers where the data may be processed and analyzed. Results of this analysis may be communicated to end users via a variety of communication channels.

### CROSS-REFERENCE TO RELATED APPLICATIONS

This applications claims priority to U.S. Provisional Patent Application Ser. No. 62/077,415, filed Nov. 10, 2014, which is hereby incorporated by reference in its entirety.

### BACKGROUND OF THE INVENTION

The present disclosure relates generally to a method of providing proactive cybersecurity monitoring for the protection of computer networks. More specifically, the present disclosure relates to a physical device combined with monitoring software, collectively termed “the system,” that actively monitors and tests the security of a network, through a cloud-based server, without need for user input. The present disclosure relates to the cybersecurity market for small to large businesses, and also to personal networks.

In today's high-tech world, most businesses use a private network to transmit and store sensitive data. Whether the network is for collecting and storing customer data or for processing transactions, these networks handle information that is not only confidential but also sensitive in nature. The large amount of data handled, coupled with insufficient network security, makes small-to-large business, specifically small-to-medium-sized business networks, vulnerable to hackers. Loss of this valuable data or unauthorized alterations to network components can cause significant financial and reputational loss for a company. Large corporations spend millions of dollars on cybersecurity solutions to protect their networks and their data. Unfortunately, current solutions for cybersecurity are expensive, unreliable, and complex to operate. The current solutions not only use complex software that scans for vulnerabilities in the network, but in addition, the security software is installed in conjunction with an operations system that is already in place, such as Linux® or Windows®. Therefore software alterations are required for each operating system, making installation of the security system highly problematic. Further, more technical knowledge is required than most small-to-medium-sized companies or individuals maintain since there may be a variety of different operating systems on a given network. Thus, there is a significant market need for a cybersecurity solution that does not rely on a specific operating system.

Security threats can arise from individual hackers, groups of hackers, or from nonhuman components such as malicious software, e.g., malware and phishing scams. This malicious software makes its way into a network, and unbeknownst to the network operators sends information to a third party. To combat these attacks, cybersecurity software, with constant monitoring, actively looks for potential threats and vulnerabilities within the network. While it may seem intuitive that security vulnerabilities should be obvious to the network operators, oftentimes these vulnerabilities go unnoticed for a number of reasons, including but not limited to, ignorance, complacency, and stealth nature of the malicious activities. The complex user interface of the cybersecurity software is also a factor, especially for small-to-medium-sized businesses and personal networks. The majority of cybersecurity software is not user-friendly and is installed on top of a current operating system.

The present disclosure provides a cost-effective, proactive cybersecurity system that proactively monitors and tests for risks and analyzes and reports cybersecurity vulnerabilities of a target network in a user-friendly platform, thus enabling the customer to take control of their own network security. The present disclosure uses a cloud-based server that enables the end user to monitor the network through access to the cloud server providing results to the interested user regardless of where the use is or what time of day it is. The present disclosure further allows for detected vulnerabilities to be addressed quickly and efficiently before they are exploited by external or internal threats. The system notifies the end user of potential vulnerabilities and fixes for identified security threats in real time. There is no current technology that meets the specific needs and addresses the problems listed above. There remains a substantial need for a device that monitors, tests, analyzes, and reports risks and cybersecurity vulnerabilities in a user-friendly, cost-effective way

### BRIEF SUMMARY OF THE INVENTION

The present disclosure relates to a physical device and software package that actively scans and test for risks, and analyzes and reports cybersecurity vulnerabilities of business networks in a proactive, adaptive, inexpensive, and user-friendly way. The system uses a physical device to provide access to the network. This device allows access to both the internal network, outward-facing assets of the network, and external, assets, for example web servers, file servers, etc. When installed, the device scans and tests both the internal and external network assets for security vulnerabilities. The results are communicated via a cloud-based service to remote servers where the data is processed and analyzed, and the results are communicated to the end user. The communication with the end user can be via web browser, mobile application, mobile device, email, or push notifications to a mobile device. This system also has the ability to actively test the end user's network for new vulnerabilities and it has the capability to adaptively learn the network's tendencies to determine if more or less frequent testing is needed, based on network assets. This methodology allows for convenient, easy-to-use, proactive cybersecurity protection at a reasonable cost, delivering much needed cybersecurity to a broader market.

The present disclosure details a system, device, and computer implemented method for detecting security vulnerabilities of a secured network. In some embodiments, restricted conditional access may be provided to a remote server over an external communications network. In some embodiments, a device may be installed on a customer network capable of two-way connection between the remote server and the customer network.

In some embodiments, the device installed on a network may include a database. The database may include executable code that includes instructions for amongst other tasks, querying a network to determine vulnerabilities.

In some embodiments, the device may include a processor for executing the executable code.

In some embodiments, computer executable code may be included that instructs the device to perform a communication sweep of the network. This communication sweep may include directing a plurality of communication attempts to network devices. Each communication attempts may include multiple communication protocols.

In some embodiments, the device may create a communication log file network device. The log file may include information derived from the communication attempts.

In some embodiments, device may perform a penetration sweep. This penetration sweep may include directing a plurality of candidate penetration probe attempts at one or more network device(s) stored on a network.

In some embodiments, the device may include an adaptive engine that may adaptable modify the frequency, type, and protocol, of probes on a device by device basis stored on the customer network.

In some embodiments, the probing of network devices may illicit a response from the network device. In some embodiments, the device may determine network vulnerabilities based upon the responses received.

In some embodiments, the device may create a penetration log file for each network device. This penetration log file may include information derived from the penetration probe attempts. In some embodiments, the device may determine network vulnerabilities based upon the responses received. In some embodiments, responses may be provided to a server, and the server may determine vulnerabilities.

In some embodiments, the device may include a protocol engine configured to communicate with network over at least one protocol layer. By way of example only, protocol layers include: physical layer, Data Link layer, Network layer, Transport layer, Session layer, Presentation layer, and Application layer of the Open Systems Interconnection model.

In some embodiments, the device may communicate operating system information, networked services, port identifier, firmware version, and software version for queried devices.

In some embodiments, device may include a communication protocol module configured to provide communication attempts for network devices.

In some embodiments, device may a penetration probe module configured to provide candidate penetration probe attempts to network devices.

In some embodiments, device may be activated upon connection of device to network and powering of device. In some embodiments, device may require activation.

In some embodiments, device may include at least two network connections. The network connections may be used to connect between an external network and the customer network. In some embodiments, connection of the device may pass all customer network external communications through device. In some embodiments, device my include housing. In other embodiments, device may be software or cloud based.

In some embodiments, a server may be provided for communicating with the device.

By way of example, vulnerabilities that may be detected by device include but are not limited to: availability for corruption; unauthorized access; system integrity; service availability; intrusion; and system compromise.

In some embodiments, the present disclosure may be implemented as a methodology. This methodology may be run locally on a customer network via an installed device, may be hosted remote from customer network, or may be installed as software on customer network.

A method in accordance with the present disclosure may include the following steps: connecting a device an external network and a customer network.

The device in accordance with rules stored in a database may perform a communication sweep of network devices, including both hardwired devices, and unwired devices, e.g. Bluetooth, Wi-Fi. In some embodiments, a communication sweep of external devices may also be implemented.

A communication log file may be created for each network device identified as a result of the communication attempts.

A penetration sweep may be performed for the identified devices. A penetration sweep may include directing penetration probe attempts at each network device. In some embodiments, the responses to these probes may be stored in a penetration log file. The penetration log file may include information provided from the plurality of candidate penetration probe attempts. Furthermore, this information may be related to the restricted conditional access of the secured network.

A protocol engine may be employed by embodiments of the present disclosure to communicate with network devices over at least one protocol layer.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 presents a component diagram of an exemplary device employing the present disclosure.

FIG. 2 illustrates a flow diagram depicting the infrastructure of an exemplary embodiment of the system and how it integrates in a network.

FIG. 3 illustrates a flowchart for an exemplary bootup sequence and automated network configuration as employed by embodiments of the present disclosure.

FIG. 4 illustrates a flow diagram depicting the critical infrastructure identification engine of an exemplary embodiment that detects, sorts, performs network security testing, and data transfer of IP-based networking devices within network and/or subnet.

FIG. 5 illustrates a flowchart for an exemplary penetration testing sequence of IP-based networking devices within network and/or subnet.

FIG. 6 illustrates a flowchart for an exemplary security results parsing engine.

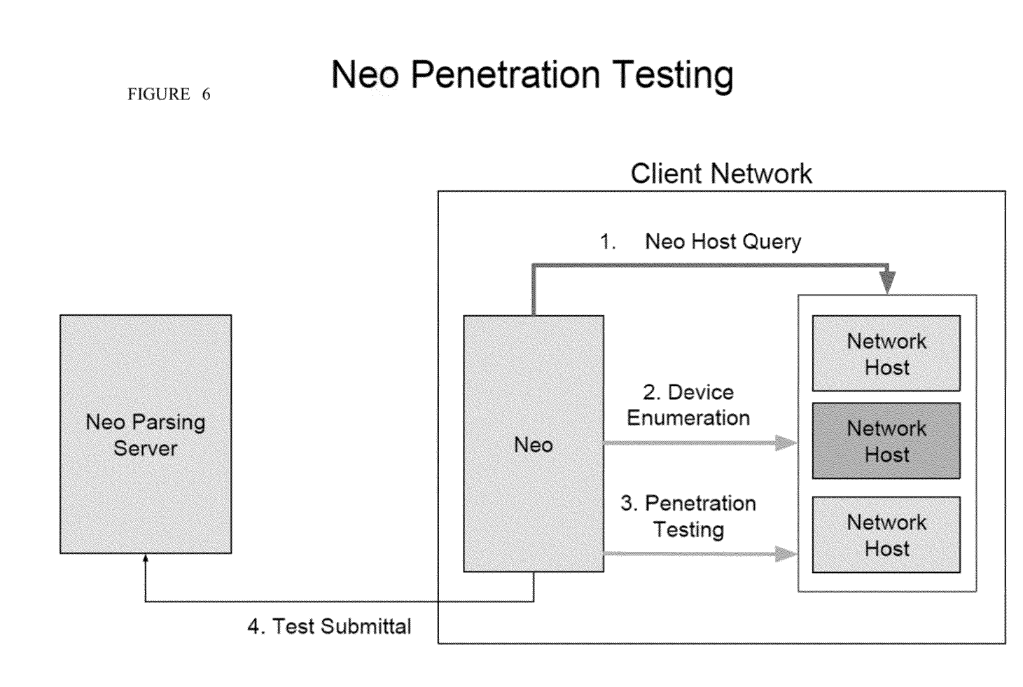

FIG. 7 illustrates a flowchart for an exemplary security results parsing engine.

FIG. 8 provides a representation of a CIP inputs arrangement.

FIG. 9 provides a flowchart for an exemplary adaptive engine as employed by embodiments.

### DETAILED DESCRIPTION OF ILLUSTRATIVE EMBODIMENTS

Reference now should be made to the figures for details to various exemplary embodiments of the disclosure. The same reference numbers are used throughout the different figures to designate the same components. Embodiments described in the description and shown in the figures are illustrative only and are not intended to limit the scope of the disclosure. Changes may be made in the specific embodiments described in this specification and accompanying drawings such that a person of ordinary skill in the art will recognize are within the scope and spirit of the disclosure. Well-known components, materials, or methods are not necessarily described in great detail so as to avoid obscuring the present disclosure.

Disclosed herein are detailed descriptions of specific embodiments of the device of the present disclosure. It will be understood that the disclosed embodiments are merely examples of ways that certain aspects of the disclosure can be implemented and do not represent an exhaustive list of all of the ways the disclosure may be embodied. Indeed, it will be understood that the systems, devices, and methods described herein may be embodied in various and alternative forms.

The present disclosure is both a physical networking device and software-as-a-service platform, which are collectively termed “the system,” along with the process by which the system tests, transmits, adapts, and displays results to an end user or network administrator. The incorporation of this system and processes into a network will provide enhanced, adaptive, and proactive cybersecurity testing and continuous monitoring to a target network. This system enhances the security through repeated testing of the network for vulnerabilities that potential threats, both internal and external, could exploit. The results of the testing are then uploaded to a server for interpretation and reporting to the network administrator.

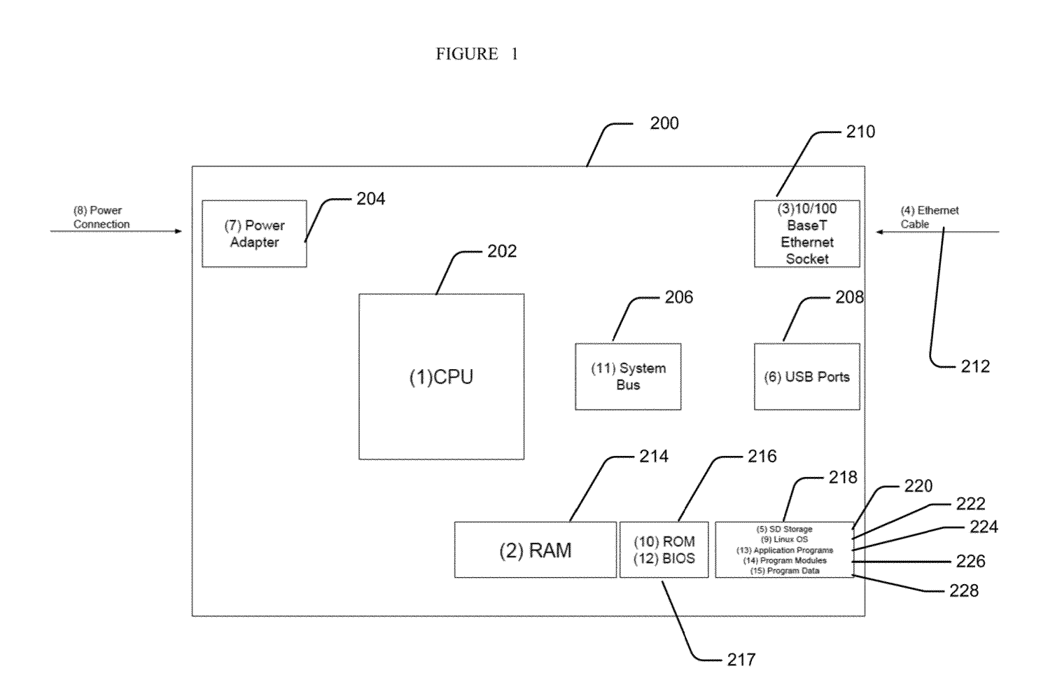

Referring now to the drawings in detail, FIG. 1 illustrates an exemplary device for implementing an automated hardware and software security solution that may probe connected networked devices over network communication protocols, for example, Transmission Control Protocol (TCP), User Datagram Protocol (UDP), Internet Protocol (IP), etc.

As shown, an embodiment may be implemented within a computing environment as a general purpose computing device in the form of a computing system commercially available from, for example, Intel, AMD, Motorola, etc. Components of the computing device 200 may include, but are not limited to, a processing unit 202, system memory 214, a system bus that couples various system components including the system memory 214 to the processing unit 202, a network adapter 210, read/write media storage 218, device input ports 208, for example Universal Serial Bus, Firewire, etc., and power input 204 in which to provide power to the device 200.

An exemplary device 200 may include a variety of computer readable media. Computer readable media can be any available media that can be accessed by the computing system and includes both volatile and nonvolatile media, and removable and non-removable media. By way of example, but not limitation, computer readable media may comprise computer storage media and communication media. Computer storage media includes volatile and nonvolatile, removable and non-removable media implemented in any method or technology for storage of information such as computer readable instructions, data structures, program modules, or other data. Computer memory includes, but is not limited to, RAM, ROM, EEPROM, flash memory or other memory technology or any other medium which can be used to store the desired information and which can be accessed by the exemplary device 200.

A device embodiment 200 may include system memory 214, including computer storage media in the form of volatile and/or nonvolatile memory such as read only memory (ROM) 216 and random access memory (RAM) 214. A basic input/output system (BIOS) 217, containing the basic routines facilitate the transfer information between elements within device 200, such as during startup, may be stored in ROM 216. RAM 214 may contain data and/or program modules that are immediately accessible to and/or presently being operated on by processing unit 202. By way of example, and not limitation, and operating system 222, application programs 224, other program modules 226, and program data 228 are shown.

A device embodiment may also include other removable/non-removable, volatile/non-volatile computer storage media. By way of example only, a Secure Digital (SD) card 220 that reads from or writes to non-removable, non-volatile media. Other removable/non-removable, volatile/non-volatile computer storage media that can be used in the exemplary operating environment include, but are not limited to, flash memory cards, solid state RAM, solid state ROM and the like.

The drives and their associated computer storage media, discussed above, provide storage of computer readable instructions, data structures, program modules and other data. For example, storage 220 is illustrated as storing operating system 222, application programs 224, program modules 226, and program data 228. Note that these components can either be the same as of different from operating system 222, application programs 224, program modules 226, and program data 228.

The central processor 202 operating pursuant to the operating system software such as, but not limited to Linux, Unix, Microsoft Windows, Apple Mac OSX and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security and security audits, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or client's system, via hardware, software module or any combination of the two. A software module (program or executable) may reside in RAM memory, flash memory, ROM memory, EPROM memory, EEPROM memory, registers, hard disk, secure digital storage, a removable disk, or any other form of storage medium known in the art. An exemplary storage medium is coupled to the processor such that the processor can read information from, and write information to, the storage medium. In the alternative, the storage medium may be integral to the processor. The processor and storage medium may also reside in an application specific integrated circuit (ASIC). The bus may be an optical or conventional bus operating pursuant to various protocols that are well known in the art.

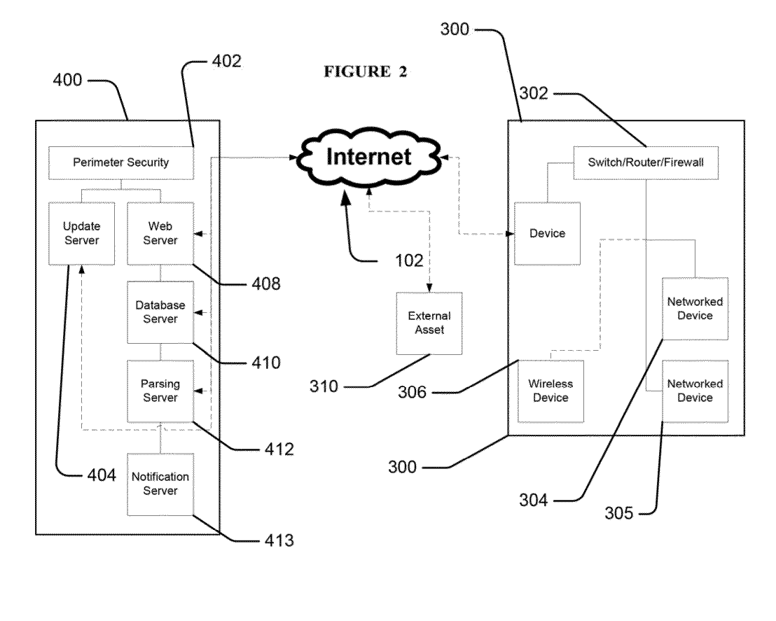

As shown in FIG. 2, a device embodiment 200 may operate in a networked environment 300 using local connections to one or more remote networked systems, such as a firewall 302, network printer 304, network computer 305, etc. The remote networked system 300 may be, for example, a personal computer (including, but not limited to, mobile electronic devices, a server, a router, a network PC, a network printer, a peer device, an Internet of Things (IoT) device, etc.), and typically includes many or all of the elements described above relative to the device 200. The logical connections depicted include a local area network (LAN) Ethernet socket port connecting through a network interface and wireless local area network (WLAN) 306 connecting through a network interface, but may also include other networks. Such networking environments are commonplace in offices, enterprise-wide computer networks, homes, intranets and the Internet.

In an exemplary arrangement employing the present disclosure, the device 200 may comprise the source machine from which data is being generated/transmitted and the remote computing system 304 and 306 may comprise the destination machine.

In another example, in the present embodiment, the remote computing system 304, 305, and 306 may comprise the source machine from which data is being generated/transmitted and device 200 may comprise the destination machine.

In a further embodiment, device 200 may comprise both a source machine from which data is being generated/transmitted and a destination machine and the remote computing system may also comprise both a source machine from which data is being generated/transmitted and a destination machine.

FIG. 2 illustrates an exemplary network topology as employed by embodiments of the present disclosure. As shown, a device embodiment 200 may be installed into the network 300. In One embodiment, this may be by a single node on the network. Once installed, device 200 may automatically scan the internal aspects of the network 300, or inward-facing assets, for potential vulnerabilities. In one embodiment, device 200 may notify the cloud server/host server 400 to initiate a test of the external aspects, or outward-facing assets, for potential vulnerabilities. This test in effect simulates an external attack on the network. After completion of the testing, both internal and external, device 200 may upload the testing results to the host cloud server 400 via the internet 102 to be analyzed. The test data may then analyzed, correlated, and stored in a database 410 for future reference or decimation. After completion of the analysis, the end user may be notified of potential vulnerabilities and suggestions for remediation of these vulnerabilities.

FIG. 2 illustrates an exemplary cloud infrastructure 400 as employed by the present disclosure. As shown, an embodiment of the cloud server may include three different servers with different functions. An update server 404 may be included to provide software updates to device 200 via the network connection. A web server 408 may be included to receive the data uploaded by device 200 and further processes it. The data received shows vulnerability testing and performance of customer network 300. The processing of this data may include threat detection. A notification server 413 may be included to disseminate the acquired and processed vulnerability and performance data to the end user via a number of methods such as, but not limited to, e-mail, SMS message, push notification, online browser, or smart phone application.

A cloud infrastructure embodiment 400 may include a host database 410 to collect and stores data from the customer network 300 assessments and tests. Data that is collected reflects, but is not limited to, the following parameters: frequency of testing, detected vulnerabilities, performance metrics of the network, and vulnerability fixes applied. The collected data may be made anonymous and disseminated to end users to show how customer network 300 compares to other performed analyses.

In an embodiment, device 200 may be used to connect the customer network 300 to the host servers 400. In an alternative embodiment, device 200 may be provided as downloadable software for install on a remote computer, as downloadable software for installation on each remote computer or device, may be provided as software running from an external host, or as some combination thereof.

Device 200 may be a network device input and output that connects to the customer network 300. In one embodiment of device 200, the connection may be made to the network as a single node on the network, so that internal assets pass through it before exiting the network as shown in FIG. 2. The act of physically installing device 200 in the network may activate the pre-installed software such that the network evaluation commences. Device 200 may allow the communication between the host servers 400 and the customer network 300 to evaluate the security of the network 300 and potential vulnerabilities that could be exploited by a third party.

In one embodiment, the connection, e.g. internet 102 between device 200 and host server 400 may be maintained as long as the device 200 is supplied with power and installed in the network 300. In some embodiment, device continuously monitors customer network 300. In some embodiments, device 200 monitors customer network 300 on predefined or inputted schedules. A device 200 may also contain a reserve power supply, such as a battery backup, to aid in power failure situations, thus maintaining network security.

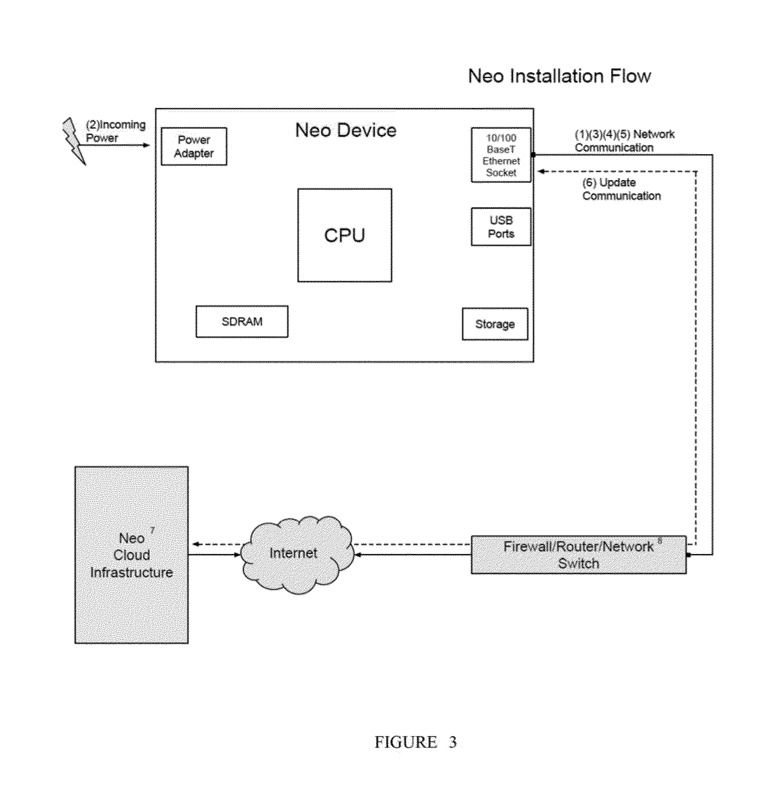

FIG. 3 illustrates an exemplary bootup sequence and automated network configuration as employed by embodiments of the present disclosure.

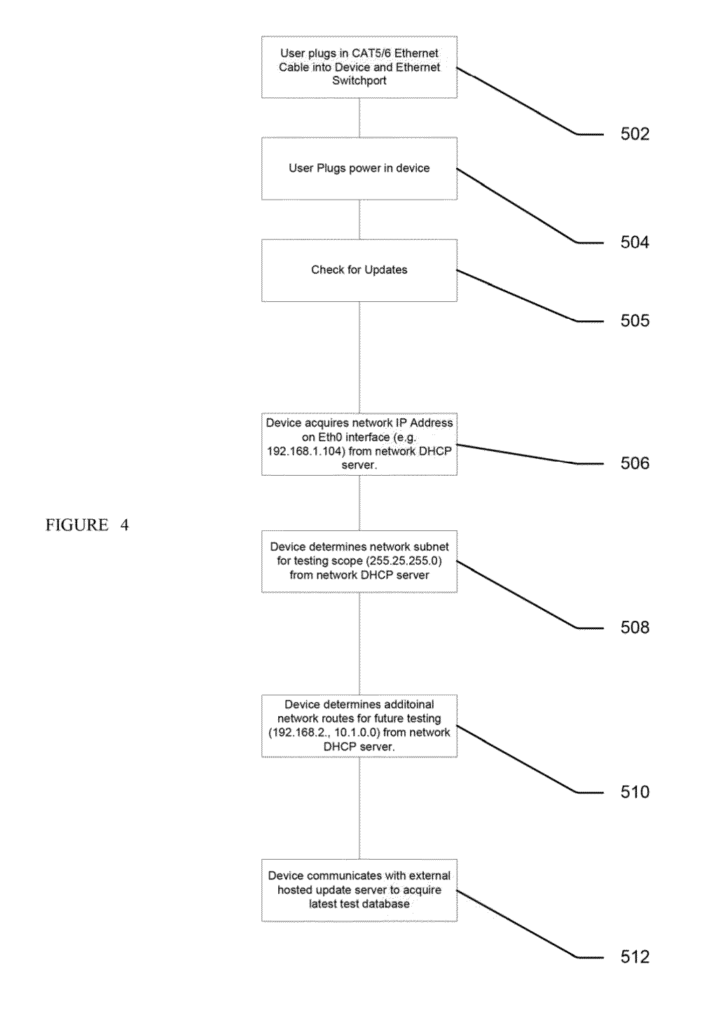

FIG. 4 depicts an exemplary process that may be used by the device 200 to detect and sort IP-based networking devices within a network 300. This process may also be applicable to a subnet of the customer network 300. The process allows for the device 200 to adaptively learn inputs and network characteristics to further tailor the proactive vulnerability testing of the customer network 300.

As shown in step 502, an Ethernet cable may be attached to device Ethernet port and connecting the second end of the Ethernet cable to a switch-port on the network. In step 504, a USB power cable between a USB port of the device 200 and a standard power socket. In an alternative embodiment, a USB-to-power adapter or other attachment may be used to power device 200.

Continuing to step 505, upon powering and connection of device 200, device 200 may automatically begin to configure itself by performing the update actions. Furthermore, device 200 may set a recurring task to check into the update server 404 for new updates in accordance with a defined schedule.

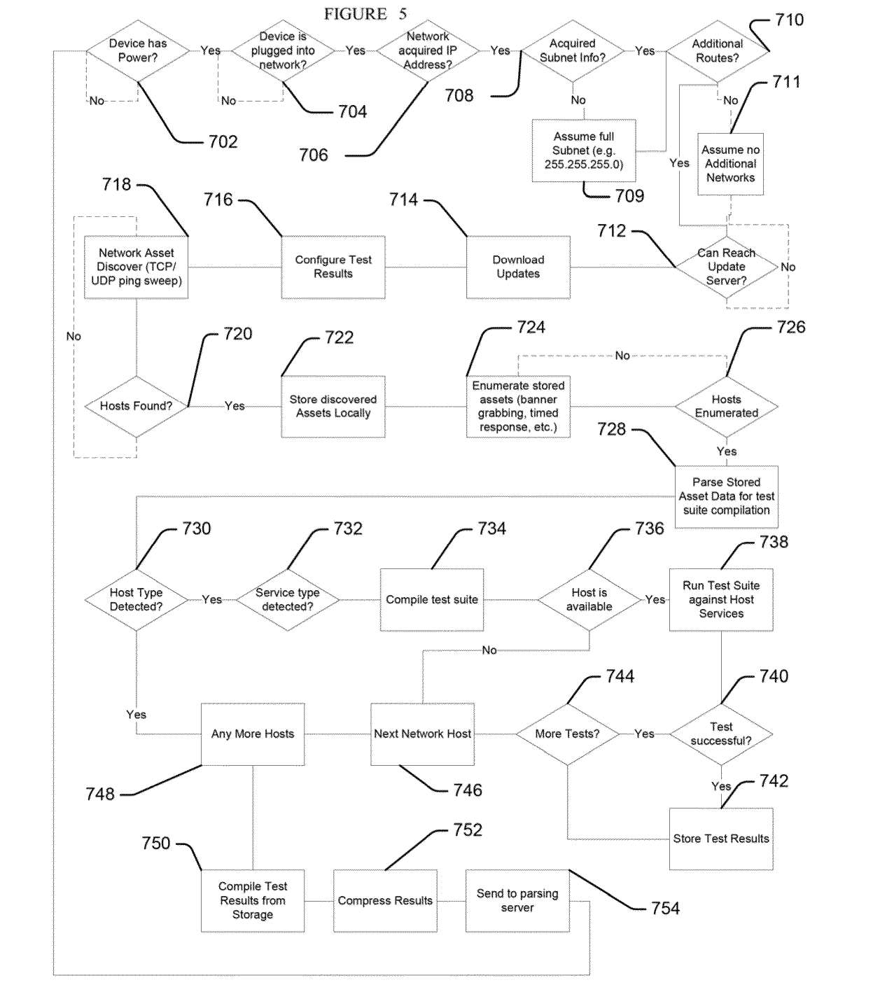

Continuing to step 506, upon completion of update device may perform automated penetration testing tasks as detailed in FIG. 5 on a predefined schedule to truly assess the security of the network it is deployed on.

As discussed, FIG. 5 presents in greater detail the methodology that may be employed by embodiments of the present disclosure in performing a penetration test on customer network 300. As shown at step 718, device 200 may first determine network devices 304, 305, and 306 located on network 300, this is done through a passive yet comprehensive IP (Internet Protocol) ping sweep of the network that device is deployed on (Ex: 192.168.1.0/24). Network devices 304, 305, and 306 may include (but are not limited to): network connected computers, portable computers (such as laptops, smartphones, tablets, PDAs, etc.), printers, network-enabled devices (such as, but not limited to: televisions, thermostats, refrigerators, coffee machines, fire alarms, camera systems, embedded systems, etc.), wireless networks, wireless access points, etc.

Should device 200 determine network devices (304, 305, and 306) found 720, process continues to step 722. Should no network devices 304, 305, and 306 be found, process reverts to step 718.

At step 722, device 200 may log all active network devices into an internal network devices log file that is located in a unique directory on device 200. In some embodiments, this unique directly may be used later by parsing servers for further testing.

At step 724, device 200 may actively communicate with each device through layers 1 (Physical), 2 (Data Link), 3 (Network), 4 (Transport), 5 (Session), 6 (Presentation), and 7 (Application) layers of the OSI (Open Systems Interconnection) model based on the IP addresses that had been previously placed into the internal network devices log file. This active and bi-directional communication channel prompts responses from each probed device 304, 305, and 306 to determine operating system, networked services, and software versions that are running on the probed device 304, 305, and 306 through advanced enumeration tactics such as response values (for example, port 443 may return “443/tcp closed indicating the port is accessible, but no service is currently listening), ‘banner-grabbing’ (for instance, the Apache Web Server returns the string: “Server: Apache/1.3.3 (Unix) (Red Hat/Linux)” indicating the server software (Apache), version (1.3.3), and Operating System (Red Hat/Linux), open ports of communication (for example, port 80 is related to HyperText Transfer Protocol (HTTP)), and response timeout values (for instance, services may respond with an error or command prompt in a more timely manner to user profiles that exist versus profiles that do not exist). If device 200 successful enumerates probed device, process continues to step 728. If enumeration of probed device is unsuccessful, process reverts to step 724.

At step 728, the results of each of tests may be placed in a log file in the unique directory on device 200. In some embodiments, this unique directly may be used later when device 200 performs advanced simulated penetration testing against each network device.

At step 730, device 200 determines network device type.

At step 732, device 200 determines service type.

At step 734, device 200 may use the information found in 718 to craft operating system and service specific penetration tests against each detected device on the network. For example, if the Apache Web Server is detected, the device will compile tests that relate to this specific version of the Web Server and exclude security tests meant for other versions. Device 200 may accomplish the crafting of specific penetration tests by establishing an active communication channel to each device through layers 1 (Physical) by determining if the given device is physically connected to the network, 2 (Data Link) by establishing direct device-to-device communication channels which can establish and terminate the connection between devices, 3 (Network) enabling IP address communication between devices, 4 (Transport) which enables data transfer between devices on the network utilizing a given protocol, such as, but not limited to, Transmission Control Protocol (TCP), etc., 5 (Session) to control the communication between the two communicating devices, 6 (Presentation) which may translate data into a format acceptable by layer 7 (Application) which may present data to the end-user in the form of an Application, for example a web browser of the OSI (Open Systems Interconnection) model and performing tests that have been queued based on analysis performed in 718. Once the custom test suite has been determined for the given network device, for instance, the device may determine that the given network device. Operating System is Microsoft Windows Server 2008 based on solicited probed service responses from a combination of ports 80 (HTTP), 443 (HTTPS), and 445 (SMB), whereas a Linux Operating System network device may return different probed service responses from the same ports, the advanced penetration test will commence using our various scripted programs, adaptive inputs, installed tools, and automated exploit analysis.

At step 736, device 200 determines if network device is available. If yes, process flow continues to step 738. If network device 304, 305, and 306 is not available, process flow continues to step 746.

At step 738, device 200 performs test suite for network device 304, 305, and 306. Upon completion of test flow, process flow proceeds to step 740.

At step 740, device 200 determines successful completion of test suite for given network device 304, 305, and 306. If successful, process flow process proceeds to step 742.

At step 742, device 200 may store the results of each penetration test for each network device in a log file in the unique directory.

At step 744, device 200 determines if additional tests are to be performed. If yes, process flow reverts to step 738. If no, process flow proceeds to step 746.

At step 746, device 200 queries database for additional network devices, wherein process flow process to step 748.

At step 748, device 200 determines on basis of query if additional network devices are available for testing. If yes, process flow reverts to step 730. If no, process flow proceeds to step 750.

At step 750, device 200 compiles test results for each network device 304, 305, and 306 tested.

At step 752, after completion of all penetration tests on all detected network devices 702, device 200 may compress results into one or more files.

At step 754, after completion of compression results may be submitted to parsing server 406 in order to present the results to the end user.

Once device 200 submits the results of penetration test to parsing server 406, the device 200 returns to a passive state to poll the update server 404 for update status. If a new update is detected, the device 200 will pull the required updates and implement those given updates in the next penetration test.

Once the device 200 application programs 224 have successfully progressed through all configuration tasks, device 200 will configure the penetration testing suite through application programs 224.

An exemplary device may commence the penetration testing suite by first determining the networked assets through a ping sweep 700. This may include sending Internet Control Message Protocol (ICMP) communication to each TCP/IP networked address within the network testing scope. If additional networked network devices 702 are found, they are stored within program data 228 files for later use. If no network devices are found the application program 224 will initialize a loop to perform the network asset discovery until network devices are detected.

After detecting networked devices 702 the detected devices are queried through communication protocols, for example, but not limited to TCP/IP, UDP, LDP, etc., for additional device information, see step 706. This may be done through service discovery techniques such as (but not limited to) banner grabbing, timed responses, standardized open ports, etc., and the results are stored within program data 228 files for later use by device 200. If no network devices are enumerated the application program 224 will initialize a loop to perform the enumeration until network devices are results are generated.

Result data is then autonomously analyzed on the device 200 to create a test suite for each network device 304, 305, and 306 and stored in program data 228. Device 200 may accomplish this by analyzing program data 228 through application programs 224 for device data such as (but not limited to) operating system information, network services, service versions, etc.

Application program 224 will then compile a custom test suite against the given network device 304, 305, and 306 identified and device services using non-malicious penetration testing attacks, for instance (but not limited to) brute force attacks, buffer overflows, heap overflows, information disclosure, denial of service, memory corruption, Cross Site Scripting (XSS), Cross Site Request Forgery (CSRF), etc. compiled through the cloud infrastructure 400 and communicated to device 200.

Application program 224 will again ensure that the network device to be tested is still reachable through an ICMP ping request made to the customer network 300. If the network device is available, the application program 224 will begin to run the compiled test suite against the network device. Successful penetration test results are stored in program data 228 files for later transmittal to the cloud infrastructure 400 for further parsing and presentation. If it is determined that there are more penetration tests to perform, this loop continues until the compiled test suite list has been exhausted, in which the application program 224 will advance to the next testable network device as determined by through earlier test compilation.

Once all tests within the test suite compilation have been exhausted stored program data 228 files are compiled and compressed using application programs 224 to submit results to the cloud infrastructure 400 parsing server.

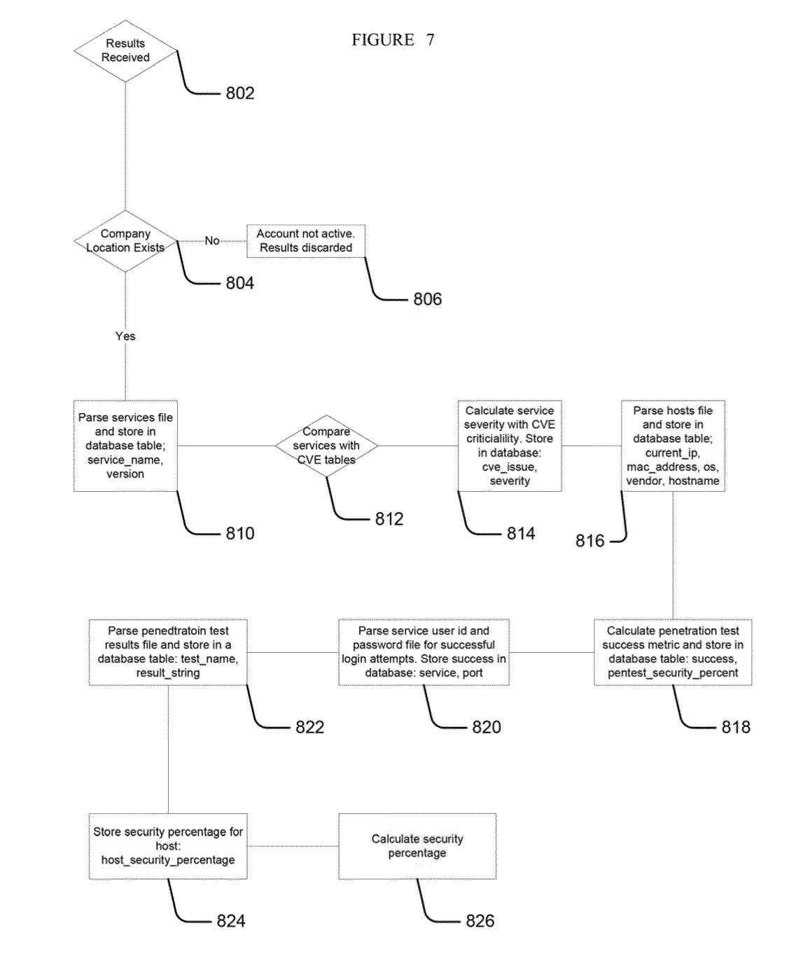

FIG. 7 illustrates an exemplary Penetration Test Data Parsing flowchart as employed by embodiments of the present disclosure. As shown in step 802, program data 228 may be received via encrypted protocols, for example (but not limited to) Secure Shell (SSH), Virtual Private Network (VPN), etc., to the cloud infrastructure 400 parsing server 406 where application programs residing on the parsing server 406 may decompress the submitted program data 228 from the remote computing system 300 to analyze, sanitize, and input into the cloud infrastructure database server 410.

At step 804, server 400 queries data for location specific information identifying the customer network 300. This program data is integral for correct database insertion and parsed for correct database input. In some embodiments, if the company location does not exist, the submitted program data may be discarded 806.

At step 810, parsing server 412 may parse the submitted program data 228 received from device 200 for customer network 300, such as (but not limited to), networked devices 304, 305, and 306, networked assets, enumerated assets, penetration testing results, etc., are submitted into the cloud infrastructure database tables 410. In some embodiments, system may discard any program data 228 that is unable to be analyzed and/or parsed.

At step 812, parsing server 412 may then analyze the parsed program data results from device 200 and comparatively analyzes the results with publicly available Common Vulnerabilities and Exposure (CVE) data to calculate (see step 814) a security percentage for customer network 300 based off publicly documented severity level and ease of implementation. This information is stored in the database 410.

At step 818, penetration test results for each networked device 304, 305 and 306 may be stored into the database 410 and analyzed to calculate the penetration test success metric based off publicly available information, including (but not limited to) Network Vulnerability Test (NVT) feeds, exploit databases, custom application program algorithms, etc., and inputted into the cloud infrastructure database table 410 for later security percentage calculation.

Device 200 may provide to server 400 login attempts for each network device. At step 820, server may parse and analyze login attempt results for each networked service for successful login attempts. For example, device 200 was able to successfully login to a networked device service such as, but not limited to, Secure Shell (SSH), File Transfer Protocol (FTP), Virtual Private Network (VPN), Telnet, Hypertext Transfer Protocol (HTTP), Hypertext Transfer Protocol Secure (HTTPS), etc. using generated user credentials (e.g., user id: admin, password: admin) to indicate weak login credentials. These results are then stored in the cloud infrastructure database server table 410 to calculate an accurate overall security percentage for a customer premise networked device 304, 305, or 306.

At step 822, the results may be placed into a secure database and test result data is parsed to later be associated with the customer account to which the device 200 is allocated.

At step 824, device 200 stores information to compare enumerated operating systems, services, and versions to establish a baseline for each individual network device which is then stored as a unique record. In some embodiments, this stored information may be stored on server 400. In some embodiments, this stored information may be stored in both locations. Each customer network and network device may receive a ‘security percentage’ based on a unique algorithm that compares all aspects and the level of security that device 200 was able to determine for the network device 304, 305, 306, and customer network 300 during its penetration testing phase. For example, a network device may receive a security percentage of ‘75%’ indicating there are security issues that may need to be addressed. In some embodiments, security percentage reports may be provided for each network device, for the customer network 300 as a whole, and for combinations thereof.

At step 826, each customer network 300 may receive a ‘security percentage’ based on algorithmic analysis performed by server 400 that compares all aspects of the device 304, 305 and 306, and the level of security determined for the customer network 300 during penetration testing.

In some embodiments, results, information, and analytics may be displayed to the end-user through the secure web application and generated during a user logging into their unique session. Once logged in, a user may be able to view current overall network security percentage based off algorithmic assessment for customer network 300.

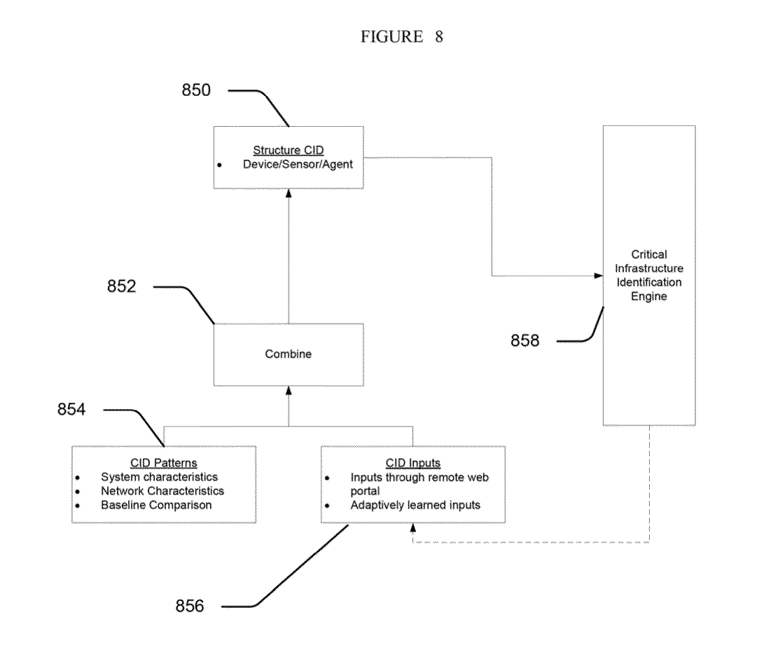

FIG. 8 illustrates a Critical Infrastructure Engine that may be employed by embodiments of the present disclosure. As shown, the Critical Infrastructure Identification Engine 858 (“CID”) may receive information from Structure CID (the device) 850. The Structure CID 850 combines (see 852) input data from both the known CID Patterns 854 provided through programming and updates, adaptive audit inputs learned from previous security audit data, and CID Inputs of the customer network 300 provided by the user through the web portal. The CID inputs may be made through a remote web portal and can be adaptively learned from previous inputs, tests, and situations. The CID Patterns 856 include, but are not limited to, system and network characteristics, and baseline comparison data of other similar networks.

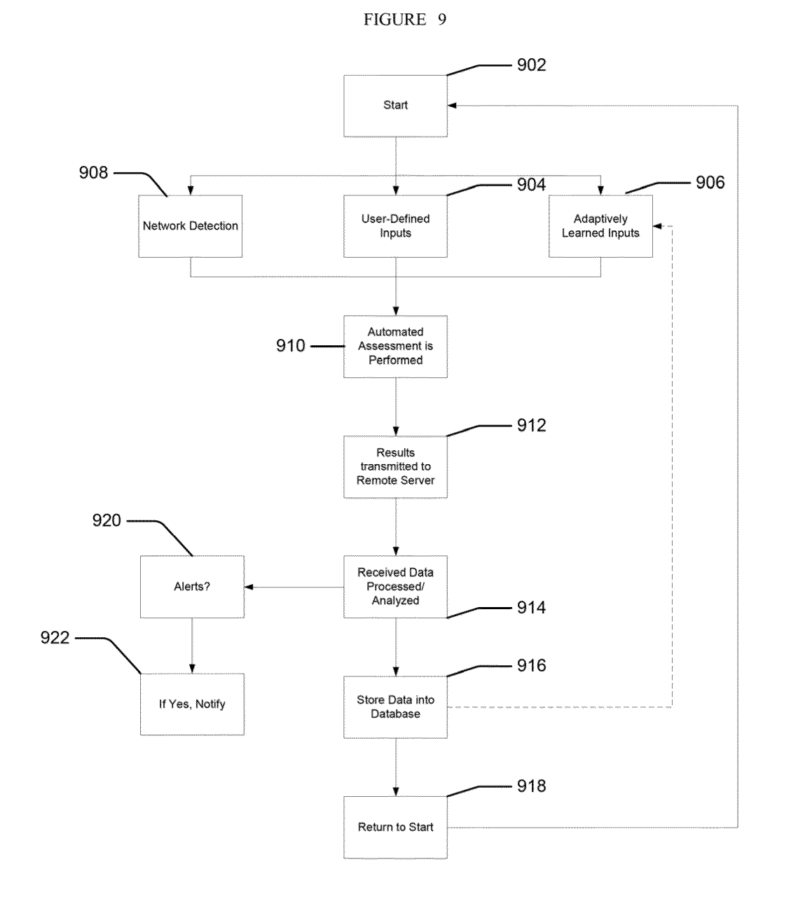

FIG. 9 depicts an exemplary continual adaptive audit process that may be used by the present disclosure to adaptively learn the customer network 300 properties and to better improve the proactive testing of the system. Implementation of this methodology ensures that network 300 is actively protected, and allows continual IP-based network security audits through adaptive learning.

In one embodiment, the assessment software is initiated upon installation of the device 200 and evaluates the customer network 300. The device may evaluate the network on a pre-defined time interval, at a post-installation defined time interval, upon request, and on some combinations thereof. Evaluation of the customer network 300 may be controlled by three criteria: Network Detection 908, User-Defined Inputs 904, and Adaptively-Learned Inputs 906. The network detection information 908 may be obtained from information gathered by the exemplary system including but not limited to, computers and devices on the network and any network protection, routing, and switching devices installed on the network, such as firewalls, routers, network switches, Intrusion Detection Systems, etc. User-defined inputs 904 include, but are not limited to, the network information provided to the system by the network operator through the web portal. Adaptively-learned inputs 906 are the inputs that the system has learned through the CID component of the software. Once the device 200 obtains the inputs from the network user through the web portal and CID inputs, the automated assessment of the network 910 may preformed and the results transmitted 912 to the remote or cloud-based server. After the data is received, it may be processed and analyzed by the system software 914, which is located on the remote host server 400. Should the system detect vulnerability 920 on the end user network, the system may alert 922 the end user. An end user alert may be by, but not limited to, text message (SMS), e-mail, phone call, push notification, mobile device application, or web browser. The notification may include a method to fix the detected vulnerability. The processed data received is stored in a database of test and network data that was taken from previous assessments conducted on the end user's network along with data taken from other end user's networks. The processed data may also be used as an input for the adaptive learning input.

In one embodiment, an alert may be provided to the end user by, but not limited to, SMS message, push notification, or phone call. The notification may include information on how to fix the vulnerability, for example, it may be determined that user authorization is not strong enough for a specific system configuration file, therefore the notification will include information including the steps required to secure the necessary file. An embodiment may also use adaptive-learning processes to learn from network activity to better tailor the security evaluations to the customer network 300. For instance, through adaptive learning, it may be determined that a remote device on the network is considered valuable due to the data stored on it, which will augment future security audits of the remote device with enhanced security testing, such as more frequent security scans, additional testing, off-hour auditing, etc. The adaptive-learning process may be accomplished through increased or decreased testing based on input from the adaptive-learning module of the software. By adaptively monitoring the system for changes and trends, the proactive testing and evaluation of the customer network 300 allows for efficient and secure monitoring of the network security without consuming a significant portion of the network's resources.

When performing security tests, the system may accept inputs from multiple sources. These sources may include, but are not limited to, the adaptive audit input which may be generated through each iteration of a security test. One purpose of the adaptive audit input is to compile a profile of systems that may be tested based off previous security tests performed in order to enhance future security test performance and results.

A device 200 at installation on customer network 300, includes a clean adaptive inputs data profile. Through completion of sweeps, adaptive input data may be aggregated. In some embodiments, a first or initial sweep or testing of customer network 300 may include ‘network detection’ and ‘user-defined’ inputs are fed into the automated assessment process.

Once the automated assessment has exhausted its testing capabilities, results may be compressed and submitted to the parsing server for further analysis.

In some embodiments, parallel to submitting test results to the parsing server, network data learned through the automated assessment process, may be stored on device 200. This network data may include information such as the network host operating system type (for example, Microsoft Windows 7), service versions (for example, Apache Web Server 1.3.3), and open communication ports (for example, 80 (HTTP), 443 (HTTPS), 21 (FTP), etc.).

In some embodiments, device 200 may utilize adaptively learned inputs 906, stored locally on device 200, or within the cloud infrastructure 400.

In one embodiment, the testing results may be transmitted from the host server 400 to an end-user device in a user-friendly, convenient-to-access manner, such as e-mail, push notification, and SMS. Within the web portal, these testing results may show potential network vulnerabilities, network statistics, comparison data to other networks, and potential fixes for identified vulnerabilities. The notification server supplies and initiates the end-user device notification. The end-user device notification can be by web browser, SMS message, e-mail, fax, push notification to a mobile device, mobile device application, and/or phone call.

In one embodiment, the data required to test the outward-facing network assets 310 and the inward-facing assets, e.g. network devices, the testing results, and the notifications of the end-user device may be transmitted by cloud-based host server 400. This arrangement limits the resources required from the customer network 300.

In one embodiment, testing results may be uploaded to cloud server 400 where results can be viewed via a web browser or mobile application, among other methods.

The terms and expressions that have been employed are used as terms of description, and not of limitation, and there is no intention in the use of such terms and expressions of excluding any equivalents of the features shown and described or portions thereof, but it is recognized that various modifications are possible within the scope of the disclosure claimed. Thus, it should be understood that although the present disclosure has been specifically disclosed by preferred embodiments and optional features, modification and variation of the concepts herein disclosed may be resorted to by those skilled in the art, and further understood that such modifications and variations are considered to be within the scope of this disclosure as defined by the appended claims. Thus, additional embodiments are within the scope of the disclosure and within the claims that follow.

In general, the terms and phrases used herein have their art-recognized meaning, which can be found by reference to standard texts, journal references, and contexts known to those skilled in the art. The preceding definitions are provided to clarify specific use in the context of the disclosure.

All patents and publications mentioned in the specification are indicative of the levels of skill of those skilled in the art to which the disclosure appertains. All references cited herein are hereby incorporated by reference to the extent that there is no inconsistency with the disclosure of this specification.

The figures are not necessarily to scale, and some features may be exaggerated or minimized to show details of particular components. Well-known components or materials are not necessarily described in great detail so as to avoid obscuring the present disclosure.

Figures illustrating the components show some elements that are known and will be recognized by one skilled in the art. The detailed descriptions of such elements are not necessary to an understanding of the disclosure, and accordingly, are herein presented only to the degree necessary to facilitate an understanding of the novel features of the present disclosure.

The present disclosure has been described with reference to particular embodiments having various features. It will be apparent to those skilled in the art that various modifications and variations can be made in the practice of the present disclosure without departing from the scope or spirit of the disclosure. One skilled in the art will recognize that these features may be used singularly or in any combination based on the requirements and specifications of a given application or design. Other embodiments of the disclosure will be apparent to those skilled in the art from consideration of the specification and practice of the disclosure, in particular by combining the specified features of one embodiment with one or more features of another embodiment. It is intended that the specification and examples be considered as exemplary in nature and that variations that do not depart from the essence of the disclosure are intended to be within the scope of the disclosure.

The present disclosure may be modified and practiced in different but equivalent manners apparent to those skilled in the art having the benefit of the teachings herein. Furthermore, no limitations are intended to the details of construction or design herein shown. It is therefore evident that the particular illustrative embodiments disclosed above may be altered or modified, and all such variations are considered within the scope and spirit of the present disclosure.

Embodiments are described in terms of “comprising,” “containing,” or “including” various components and steps. All numbers and ranges disclosed above may vary by some amount. Whenever a numerical range with a lower limit and an upper limit is disclosed, any number and any included range falling within the range are specifically disclosed. In particular, every range of values (or the form, “from about a to about b” or “from approximately a to b,” or “from approximately a-b”) disclosed herein is to be understood to set forth every number and range encompassed within the broader range of values. Also, the terms in the claims have their plain, ordinary meaning unless otherwise explicitly defined. Moreover, the indefinite articles “a” or “an” as used in the claims are defined herein to mean one, at least one, or more than one of the elements that it introduces.

Insofar as the description above and the accompanying drawings disclose any additional subject matter that is not within the scope of the claims below, the disclosures are not dedicated to the public, and the right to file one or more applications to claim such additional disclosures is reserved.

What is claimed is:

1. A system for automatically detecting security vulnerabilities of a secured network, the secured network configured for restricted conditional access over an external communications network, the secured network including at least one network asset, the at least one network asset configured for communication via at least one communication protocol, said system comprising:
a device configured for communications over the external communications network with the at least one external facing network asset, the device comprising:
a database having executable code stored thereon;
a processor for executing the executable code stored in said database to automatically perform the steps of:
performing a communication sweep, the communication sweep directing a plurality of communication attempts to at least one candidate network asset, each of the plurality of communication attempts comprising one of a plurality of candidate communication protocols;
creating a communication log file for each of said at least one candidate network asset, said communication log file comprising communication log information provided from the plurality of communication attempts, said communication log information relating to the plurality of candidate communication protocols for each of said at least one candidate network asset;
performing a penetration sweep, the penetration sweep directing a plurality of candidate penetration probe attempts to each of said at least one candidate network asset, each of the plurality of candidate penetration probe attempts performed in relation to:
said at least one candidate network asset response; and
adaptive engine for modifying candidate penetration probe attempts based on a previous test result;
wherein probes plurality of candidate penetration probe attempts illicit responses from at least one candidate network asset related to a vulnerability;
creating a penetration log file for each of said at least one candidate network asset, said penetration log file comprising penetration log information provided from the plurality of candidate penetration probe attempts, said penetration log information relating to the restricted conditional access of the secured network, said penetration log information comprising information for at least one vulnerability for each of said at least one candidate network asset.

2. A system according to claim 1 and further comprising:
said device comprising a protocol engine configured for communicating with said at least one network asset over at least one protocol layer, said at least one protocol layer selected from the group consisting of the following:
physical layer, Data Link layer, Network layer, Transport layer, Session layer, Presentation layer, and Application layer of the Open Systems Interconnection model.

3. A system according to claim 1 and further comprising:
said communication log information further comprising information selected from the group consisting of the following:
operating system information of the at least one candidate network asset, networked services information of the at least one candidate network asset, a port identifier of the at least one candidate network asset, a firmware version of the at least one candidate network asset, and a software version of the at least one candidate network asset.

4. A system according to claim 1 and further comprising:
a communication protocol module configured to provide said plurality of communication attempts each comprising one of a plurality of candidate communication protocols to each of said at least one candidate network asset.

5. A system according to claim 1 and further comprising:
a penetration probe module configured to provide said plurality of candidate penetration probe attempts to each of said at least one candidate network asset.

6. A system according to claim 1 and further comprising:
said plug and play device further comprising:
at least two network connections;
a power supply; and
a housing.

7. A system according to claim 1 and further comprising:
the at least one candidate network asset comprising a server, said plug-and-play device in communication with said server.

8. The system of claim 1, wherein said vulnerability is at least one of:
availability for corruption;
unauthorized access;
system integrity;
service availability;
intrusion;
system compromise

9. A method for automatically detecting security vulnerabilities of a secured network, the secured network configured for restricted conditional access over an external communications network, the secured network including at least one network asset, the at least one network asset configured for communication via at least one communication protocol, said method comprising:
connecting a device for communication over the external communications network with the at least one external facing network asset, the device having a database having executable code stored thereon, the device having a processor for executing the executable code stored in said database;
performing a communication sweep via the device, the communication sweep directing a plurality of communication attempts to at least one candidate network asset, each of the plurality of communication attempts comprising one of a plurality of candidate communication protocols;
creating a communication log file for each of said at least one candidate network asset via the device, said communication log file comprising communication log information provided from the plurality of communication attempts, said communication log information relating to the plurality of candidate communication protocols for each of said at least one candidate network asset;
performing a penetration sweep via the device, the penetration sweep directing a plurality of candidate penetration probe attempts to each of said at least one candidate network asset, each of the plurality of candidate penetration probe attempts performed in relation to said communication log information;
creating a penetration log file for each of said at least one candidate network asset via the device, said penetration log file comprising penetration log information provided from the plurality of candidate penetration probe attempts, said penetration log information relating to the restricted conditional access of the secured network, said penetration log information comprising information for at least one access condition for each of said at least one candidate network asset.

10. A method according to claim 8 and further comprising:
via a protocol engine of said device communicating with said at least one network asset over at least one protocol layer, said at least one protocol layer selected from the group consisting of the following:
physical layer, Data Link layer, Network layer, Transport layer, Session layer, Presentation layer, and Application layer of an Open Systems Interconnection model.

11. A method according to claim 8 and further comprising:
generating via said plurality of communication attempts communication log information further including information selected from the group consisting of the following:
operating system information of the at least one candidate network asset, networked services information of the at least one candidate network asset, a port identifier of the at least one candidate network asset, a firmware version of the at least one candidate network asset, and a software version of the at least one candidate network asset.

12. A method according to claim 8 and further comprising:
providing via a communication protocol module said plurality of communication attempts each comprising one of a plurality of candidate communication protocols to each of said at least one candidate network asset.

13. A method according to claim 8 and further comprising:
providing via a penetration probe module configured to provide said plurality of candidate penetration probe attempts to each of said at least one candidate network asset.
